(19) United States
(12) Patent Application Publication
(10) Pub. No.: US 2013/0316114 A1
(43) Pub. Date: Nov. 28, 2013

(54) SCREEN PROTECTOR

(71) Applicant: Shan-Tien Hwang, Taipei City (TW)

(72) Inventor: Shan-Tien Hwang, Taipei City (TW)

(73) Assignee: TOPBOUND TECHNOLOGY INC., New Taipei City (TW)

(21) Appl. No.: 13/480,297

(22) Filed: May 24, 2012

(51) Int. Cl. C09J 7/02; B32B 27/42; B32B 27/36; B32B 7/12; B32B 33/00

(52) U.S. Cl. 428/41.7; 428/354; 428/201

(57) ABSTRACT

The present invention relates to a screen protector, comprising: a thin film substrate 21; a coating layer 11, being coated on the top surface of the thin film substrate 21; a plurality of transparent protruding points 211, being formed on the bottom surface of the thin film substrate 21; a print layer 31, being attached to the bottom surface of the thin film substrate 21 and surrounding the plurality of transparent protruding points 211; and an adhesive layer 41, being connected to the print layer 31.

### BACKGROUND OF THE INVENTION

1. Technical Field

The present invention relates to a screen protector, and more particularly, preventing the bubbles and the Newton ring from attaching to a screen.

2. Description of Related Art

With the evolution of the technology, many electronic products(ex. cell phone, or digital camera) are indispensable in life. For preventing the scratch of screen of cell phone or digital camera, the screen protector is used to attach on the screen. However, when attaching the screen protector on the surface of the screen with dust, it would produce the bubbles between screen protector and the screen to effect the function of displaying. Accordingly, in view of the shortcoming of the screen protector , the inventor of the present application has made great efforts to make inventive research thereon and eventually provided a screen protector.

### BRIEF SUMMARY OF THE INVENTION

The main objective of the present invention is to provide a screen protector, comprising a plurality of transparent protruding points to prevent the bubbles producing from attaching, the adhesion and newton ring from pressing the screen.

Accordingly, to achieve the main objective, the inventor processes a screen protector, comprising: a thin film substrate 21; a coating layer 11, being coated on the top surface of the thin film substrate 21; a plurality of transparent protruding points 211, being formed on the bottom surface of the thin film substrate 21; a print layer 31, being attached to the bottom surface of the thin film substrate 21 and surrounding the plurality of transparent protruding points 211; and an adhesive layer 41, being connected to the print layer 31.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a practical application diagram of the screen protector according to the present invention;

FIG. 2 is a cross-section diagram of the screen protector according to the present invention;

FIG. 3 is an exploded cross-section diagram of the screen protector according to the present invention;

### DETAILED DESCRIPTION OF THE INVENTION

To more clearly describe a screen protector according to the present invention, embodiments of the present invention will be described in detail with reference to the attached drawings hereinafter.

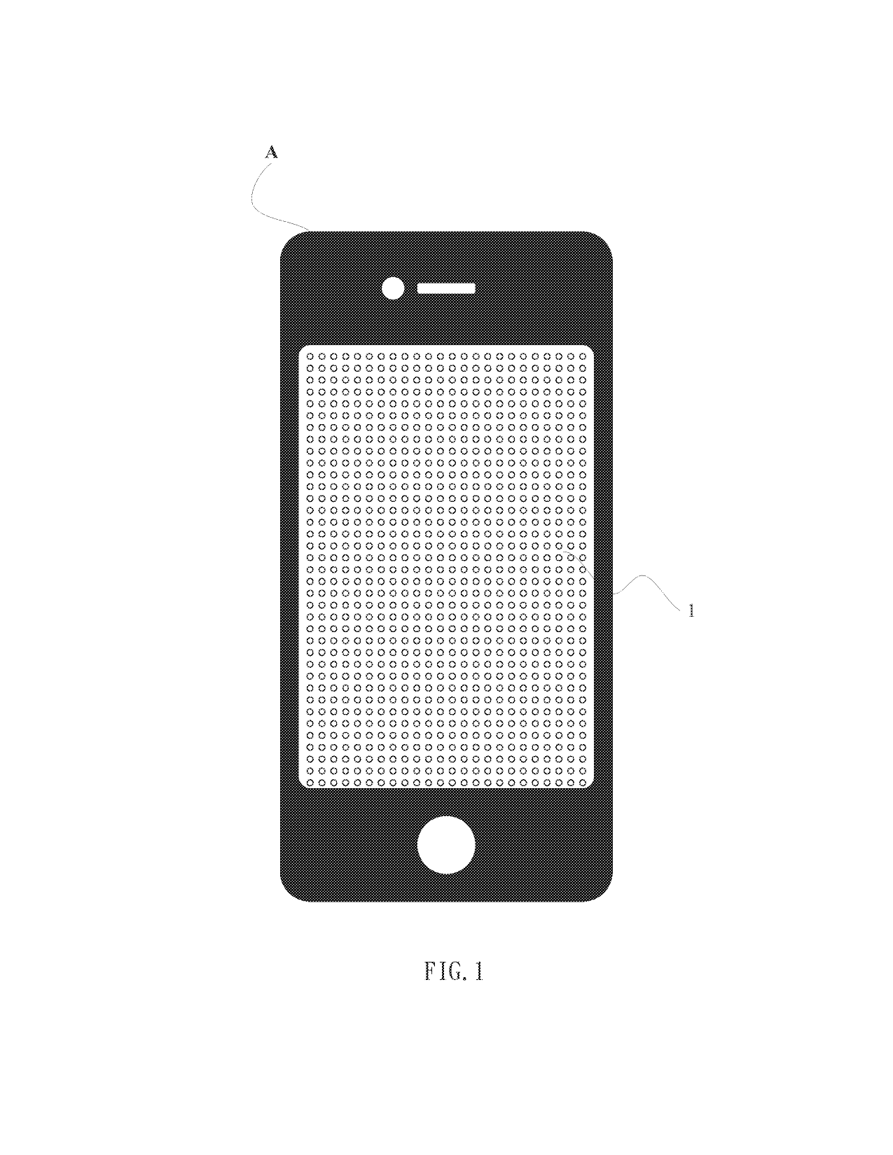

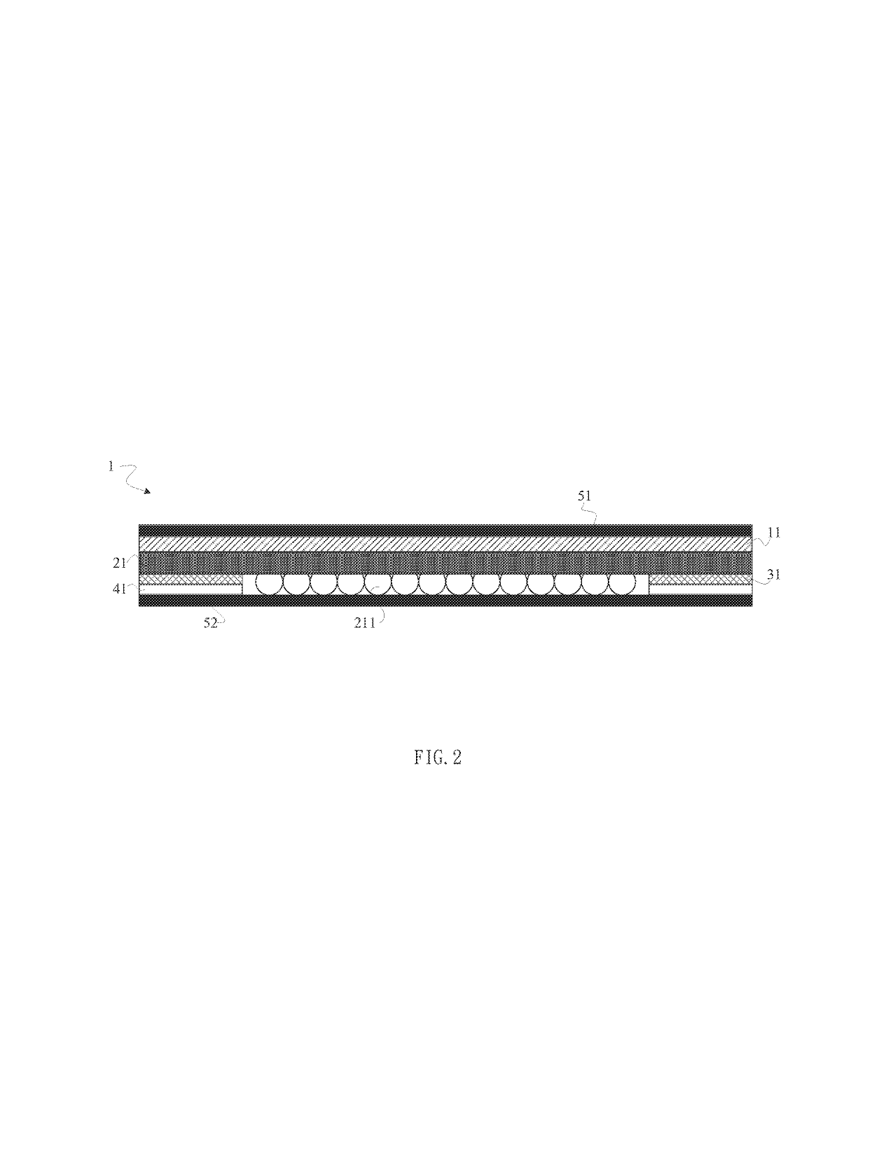

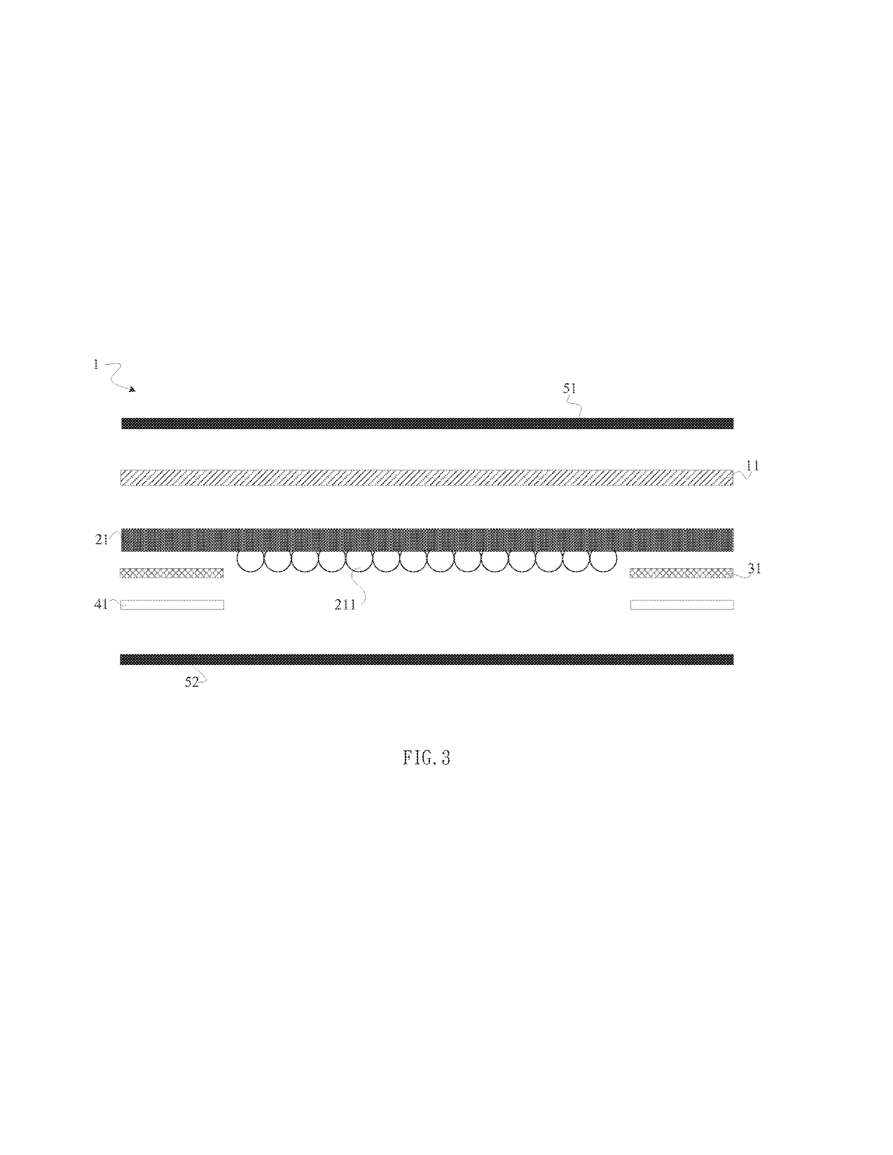

With reference to FIG. 1, FIG. 2 and FIG. 3 which illustrates a practical application diagram, a cross-section diagram, and an exploded cross-section diagram of the screen protector according to the present invention. As shown in FIG. 1, the screen protector can be used on a screen of a cell phone(A) and the screen protector comprises: a thin film substrate 21, which is made from PET (polyethylene glycol terephthalate) or PC(Polycarbonate); a coating layer 11, being coated on the top surface of the thin film substrate 21, wherein the coating layer 11 is provided functions of anti-scraping, anti-fingerprint, and lines-designing; a plurality of transparent protruding points 211, being formed on the bottom surface of the thin film substrate 21, wherein the transparent convex points are made of resin by using etching or printing process; on the other hand, because the transparent convex points produce a small space between the screen and screen protector, the adhesion or newton ring between the screen and screen protector could be prevented;

a print layer 31, being attached to the bottom surface of the thin film substrate 21 and surrounding the plurality of transparent protruding points 211, wherein the color of the print layer 31 can be modulated; an adhesive layer 41, being connected to the print layer 31, and as shown in FIG. 1, the adhesive layer 41 would be only attached to the black area of the cell phone(A); a first release film 51, being connected to the top of the coating layer 11 for preventing the coating layer 11 from damaging; and a second release film 52, being connected to the bottom of the adhesive layer 41 for maintaining the stickiness of the adhesive layer 41; However, user could just tear out the second release layer 52 to attach the screen protector to a screen.

Thus, through the embodiment, the screen protector of the present invention has been completely and clearly disclosed in the above description, and in summary, the present invention has the following advantages:

1. The print layer and the adhesive layer are attached to the bottom surface of the thin film substrate and surrounding the thin film substrate, and it produce a small space between the screen and the screen protector to prevent bubbles from attaching.
2. To form a plurality of transparent protruding points 211 on the bottom surface of the thin film substrate 21 for producing a small space between the screen protector and the screen, and it could prevent adhesion from pressing the screen.

The above description is made on embodiments of the present invention. However, the embodiments are not intended to limit scope of the present invention, and all equivalent implementations or alterations within the spirit of the present invention still fall within the scope of the present invention.

1. A screen protector, comprising:
a film substrate;
a coating layer, being coated on the top surface of the film substrate;
a plurality of transparent protruding points, being formed on the bottom surface of the film substrate, wherein the transparent protruding points produce a small space between a screen and screen protector, so the adhesion or newton ring could be prevented:
a print layer, being attached to the bottom surface of the film substrate and surrounding the plurality of transparent protruding points; and
an adhesive layer, being connected to the print layer.

2. The screen protector of claim 1, wherein the coating layer is provided functions of anti-scraping, anti-fingerprint, and lines-designing.

3. The screen protector of claim 1, wherein the material of the film substrate is selected from the group consisting of: PET (polyethylene glycol terephthalate) and PC (Polycarbonate).

4. The screen protector of claim 1, wherein the transparent protruding points are made of resin by using etching or printing process.

5. The screen protector of claim 1, wherein the color of the print layer can be modulated during manufacture.

6. The screen protector of claim 1, further comprising:
a first release film, being connected to the top of the coating layer for preventing the coating layer from damaging; and
a second release film, being connected to the bottom of the adhesive layer for maintaining the stickiness of the adhesive layer.
